(19) United States
(12) Patent Application Publication
(10) Pub. No.: US 2011/0017929 A1
(43) Pub. Date: Jan. 27, 2011

(54) Low volume automatic bathroom flushers

(76) Inventors: Fatih Guler, Winchester, MA (US); Kay Herbert, Winthrop, MA (US); John R. Wilson, Naperville, IL (US); Jean F. Daher, Auburn, MA (US); Xiaoxiong Mo, Lexington, MA (US)

Correspondence Address: IVAN DAVID ZITKOVSKY PH.D PC, 5 MILITIA DRIVE, LEXINGTON, MA, 02421, US

(21) Appl. No.: 12/800,473

(22) Filed: May 14, 2010

Related U.S. Application Data
(63) Continuation-in-part of application No. 12/655,696, filed on Jan. 4, 2010.
Application No. 12/655,696 is a continuation of application No. PCT/US2008/008242, filed on Jul. 3, 2008.
Application No. PCT/US2008/008242 is a continuation-in-part of application No. 11/716,546, filed on Mar. 9, 2007, now abandoned.
Application No. 11/716,546 is a continuation of application No. 10/783,701, filed on Feb. 20, 2004, now Pat. No. 7,188,822.
(60) Provisional application No. 61/216,321, filed on May 14, 2009.
(60) Provisional application No. 60/958,358, filed on Jul. 3, 2007.
(60) Provisional application No. 60/999,591, filed on Oct. 19, 2007.
(60) Provisional application No. 60/448,995, filed on Feb. 20, 2003.

(51) Int. Cl. F16K 31/02

(52) U.S. Cl. 251/129.01

(57) ABSTRACT

An automatic toilet room flush valve including a valve body having an inlet and an outlet, a valve cartridge and an electronic control module. The valve cartridge is disposed inside the valve body and includes a valve member and a flow regulator. The flow regulator is designed to limit water flow. The valve member is constructed and arranged to control water flow from the inlet to the outlet. The electronic control module receives signals from a sensor and controls operation of an actuator which in turn controls the valve member. The valve member includes a fram assembly, or a diaphragm, or a piston.

This application claims priority from U.S. Provisional Application 61/216,321, filed on May 14, 2009. This application is also a continuation-in-part of U.S. application Ser. No. 12/655,696, filed on Jan. 4, 2010, which is a continuation of PCT Application PCT/US2008/008242, filed on Jul. 3, 2008, which claims priority from U.S. Provisional Application 60/958,358 filed on Jul. 3, 2007, and claims priority from U.S. Provisional Application 60/999,591 filed on Oct. 19, 2007. This application is also a continuation-in-part of U.S. application Ser. No. 11/716,546, filed on Mar. 9, 2008, which is a continuation of U.S. application Ser. No. 10/783,701, filed on Feb. 20, 2004, now U.S. Pat. No. 7,188,822, which claims priority, from U.S. Provisional Application 60/448,995, filed on Feb. 20, 2003. All the above-listed applications are incorporated by reference.

### FIELD OF THE INVENTION

The present inventions are directed to automatic bathroom flushers providing low water volume.

### BACKGROUND OF THE INVENTION

Automatic bathroom flushers have become increasingly prevalent, particularly in public restrooms, both for flushing toilets and urinals. Such flushers contribute to hygiene, facility cleanliness, and water conservation.

There are several types of tankless bathroom flushers on the market including flushers supplied by Sloan Valve Company, for example, sold as ROYAL® or GEM® flush valves. ROYAL® flush valves may be manually operated, or automatically operated using OPTIMA® controllers and infrared sensors. In general, bathroom flushers receive a pressurized water supply at an input and provide flush water at an output during a flush cycle. The flush cycle provides a predetermined amount of water (depending on the external water pressure) even though there is no water tank.

In manual flushers, users initiate a flushing cycle by displacing a handle that controls a flushing mechanism including a piston or a flexible diaphragm. The handle movement causes a water leak from a control or pilot chamber to the flusher's output, which lowers pressure in the pilot chamber. Due to the lower pressure, the external water pressure lifts the flusher's piston or diaphragm from a valve seat thereby enabling water flow. The stroke of the piston or diaphragm controls the volume of water passing through the flush valve. After some time, the pressure in the pilot chamber increases (through a control passage) forcing the piston or diaphragm onto the valve seat and thus terminating the water flow.

In automatic flushers, an object sensor initiates the flushing cycle, where an actuator opens a relief passage enabling water flow from the pilot chamber to the flusher's output. This flow lowers pressure in the pilot chamber. Due to the lower pressure, as mentioned above, the external pressure lifts the flusher's piston or diaphragm from a valve seat thereby enabling main water flow used for flushing. After the actuator seals the relief passage, the pressure in the pilot chamber increases forcing the piston or diaphragm onto the valve seat and thus closing the water flow. Manual flush valves (e.g., ROYAL® flush valves) may be converted into automatically operated valves using a controller and sensor unit, sold under the name OPTIMA® by Sloan Valve Company. Overall, the flush valves supplied by Sloan Valve Company are durable, highly reliable, and suitable for long-term operation.

There is, however, a need for improved automatic flushers due to a high demand for flushers and their need in thousands of restrooms.

### SUMMARY OF THE INVENTION

The present inventions are directed to automatic bathroom flushers and preferably bathroom flushers proving low water volume. The present inventions are also directed to automatic novel bathroom flushers enabling easy servicing and adjustments and optional optimal operation.

According to one aspect, the present invention is an automatic bathroom flusher and a method for automatically flushing a toilet or a urinal. The automatic toilet room flush valve includes a valve body having an inlet and an outlet, a valve cartridge, and an electronic control module. The valve cartridge is disposed inside the valve body and includes a valve member and a flow regulator. The flow regulator is designed to limit water flow. The valve member is constructed and arranged to control water flow from the inlet to the outlet. The electronic control module receives signals from a sensor and controls operation of an actuator which in turn controls the valve member.

Preferably, the valve member includes a fram assembly, or a diaphragm, or a piston. Preferably, the valve member is controlled by an actuator. The actuator may be an electromagnetic actuator. The electromagnetic actuator is a latching actuator, or a non-latching actuator. The electromagnetic actuator may include an isolation membrane for containing fluid surrounding a plunger inside a plunger cavity.

Preferably, in the bathroom flusher, the valve member includes a fram assembly. The fram assembly includes a fram piston sliding within a guiding enclosure, wherein the fram piston is constructed to move to an open position enabling fluid flow from the fluid input port to the fluid output port upon reduction of pressure in a fram chamber; and is constructed to move to a closed position, upon increase of pressure in the fram chamber The fram piston may include a sliding seal. The sliding seal may be a one-sided seal. The sliding seal may be a two-sided seal. The bathroom flusher includes an electromagnetic actuator constructed and arranged to release pressure in the fram chamber and thereby initiate movement of the fram piston from the closed position to the open position.

According to another aspect, an automatic bathroom flusher includes a valve body having an inlet and an outlet, and a valve seat inside the body. The flush valve also includes a valve member (i.e., a flush valve mechanism) and an external cover. The valve member is cooperatively arranged with the valve seat, wherein the valve member is constructed and arranged to control water flow between the inlet and the outlet. The movement of the valve member between open and closed positions is controlled by water pressure inside a pilot chamber.

According to yet another aspect, an automatic bathroom flusher includes a valve body including an inlet and an outlet and a valve seat inside the body. The valve also includes a valve member cooperatively arranged with the valve seat, wherein the valve member is constructed and arranged to control water flow between the inlet and the outlet. The flusher also includes an external cover designed for enclosing an electronic control module comprising a battery, and a sensor.

Preferred embodiments of the above aspects include one or more of the following features: The external cover includes main cover body, a front cover and a top cover. The front cover includes an optical window, wherein the sensor is an optical sensor geometrically aligned with the optical window. The main cover body provides overall rigidity to the external cover. The individual cover parts of the external cover enable separate servicing and replacement of the cover parts.

The sensor may be an optical sensor and the sensor window is an optical window. Alternatively, the sensor includes an ultrasonic sensor or a heat sensor designed to detect body heat. Alternatively, the sensor is a near-infrared sensor that detects optical radiation in the range of about 800 nm to about 1500 nm. Alternatively, the sensor is a presence sensor. Alternatively, the sensor is a motion sensor.

The top cover is removable while maintaining the front cover, including a sensor window located in place with respect to the main cover body. The flush valve is further constructed to adjust detection sensitivity of the sensor while maintaining the optical window located on the main cover body.

The top cover may include at least one side surface designed for facilitating removal of the top cover. The top cover is attached with respect to the valve body using at least one screw, wherein tightening of the at least one screw attaches the main cover body, the front cover, and the top cover to a pilot cap defining the pilot chamber and attached to the valve body.

The external cover may include a vent passage for venting water from inside the external cover. The top cover includes a button constructed to move between upper and lower positions and designed for manually triggering a flush cycle when pushed to the lower position. The movable button includes a magnet co-operatively arranged with a reed sensor capable of providing a signal to a microcontroller.

According to another aspect, an automatic flusher system includes a flusher body including a water conduit having at least one inlet for receiving water and at least one outlet for providing water to a toilet or a urinal, and a main valve. The automatic flusher system also includes an optical sensor; and a control circuit arranged to control operation of the optical sensor. The control circuit includes a controller for executing an algorithm identifying behavior of a user over a predefined time period within a sensing field of the optical sensor and based on the behavior issuing a flush command for a predefined amount of water. The main valve is controlled by an actuator receiving signals corresponding to the flush command for switching between an open state of the valve and a closed state of the valve; the open state permitting water flow of the amount of water, and a closed state of the valve preventing fluid flow from the outlet.

Preferably, the controller is programmed to execute an algorithm including several predefined target states based on a possible behavior of the user over a predefined time period within the sensing field of the optical sensor. The controller algorithm identifies the user initially moving in and thus entering a first of the predefined target states and progressing through a succession of the target states and later moving away from the optical sensor. The target states may include sitting and standing action of the user.

The controller may issue the flush command including a half-flush of the water amount. The controller may issue the flush command including a full-flush of the water amount. The controller may issue the flush command after a predefined time period regardless of any action by the user. The predefined time period may be 24 hours. Additional description of this aspect is provided in PCT Application PCT/US2003/041303, filed on Dec. 26, 2003, which is incorporated by reference.

### BRIEF DESCRIPTION OF THE DRAWINGS

FIG. 1 is a front view of an automatic bathroom flusher providing a low water volume for flushing a toilet or a urinal.

FIG. 1A is a front view of another embodiment of an automatic bathroom flusher providing a low water volume for flushing a toilet or a urinal.

FIG. 2 illustrates diagrammatically control electronics and components used in the automatic bathroom flusher.

FIG. 3 illustrates diagrammatically control electronics and components used in another embodiment of the automatic bathroom flusher.

FIG. 4 is a perspective exploded view of the automatic bathroom flusher shown in FIG. 1 or FIG. 1A.

FIGS. 5 and 6 are cross-sectional views of the automatic bathroom flusher shown in FIG. 4 without an electronic control module.

FIG. 7 is a perspective exploded view of a flusher insert shown in FIGS. 5 and 6.

FIG. 7A is a perspective view of the flusher insert shown in FIG. 7.

FIG. 8 is a cross-sectional view of the flusher insert shown in FIG. 7A.

FIGS. 8A and 8B are exploded views of portions of the flusher insert shown in FIG. 8.

FIGS. 9 and 9A are perspective views of alternative embodiments of the flusher insert

### DETAILED DESCRIPTION OF ILLUSTRATED EMBODIMENTS

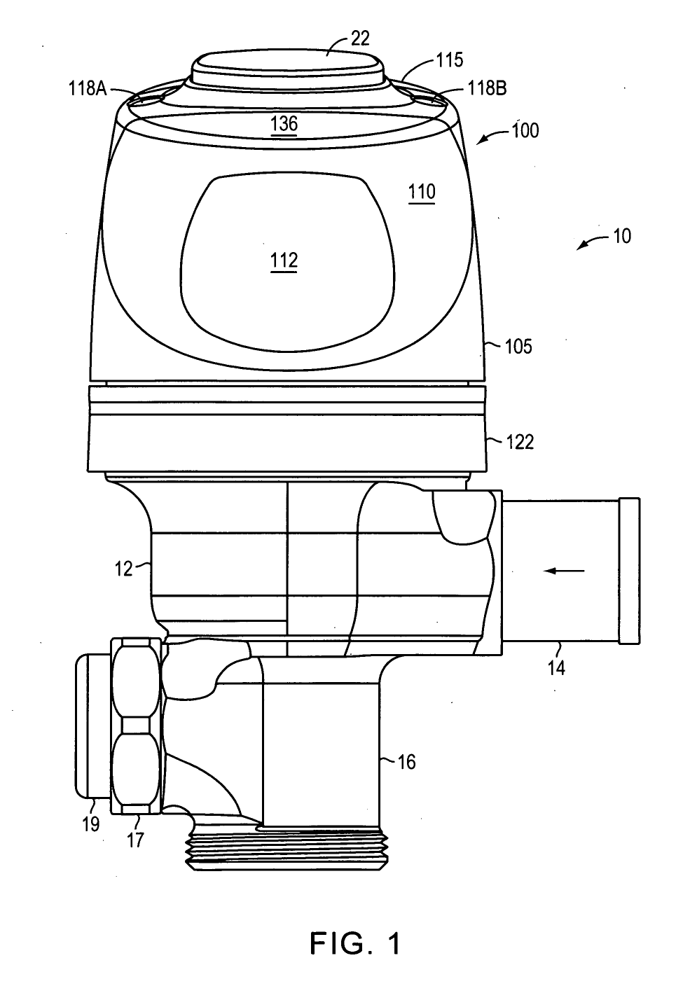

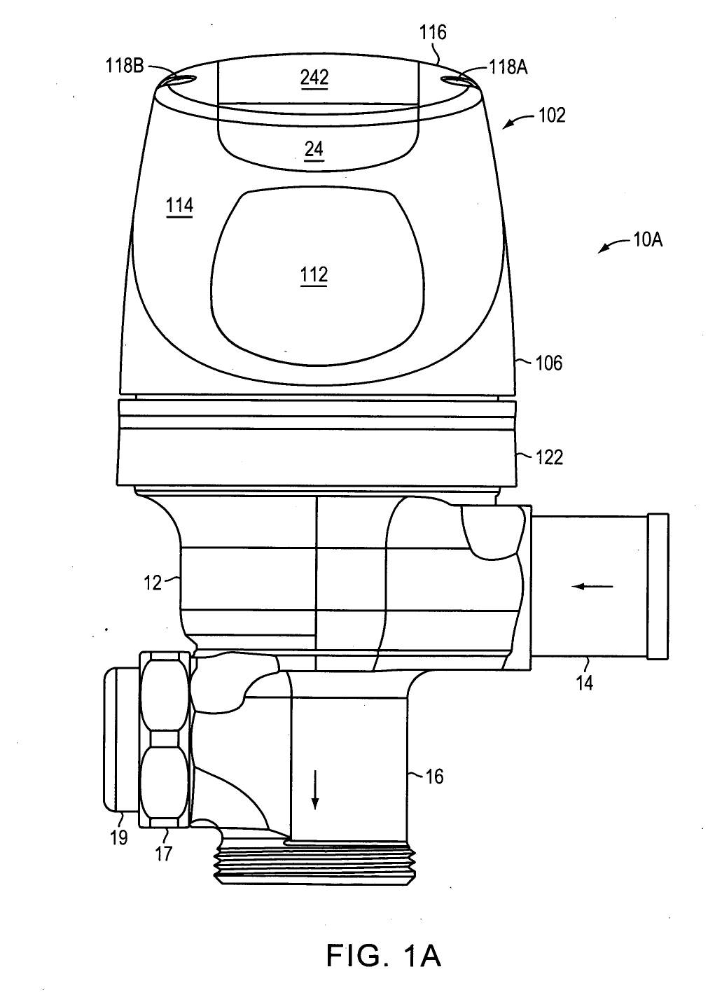

FIG. 1 is a perspective view of an automatic bathroom flusher for flushing toilets or urinals. An automatic bathroom flusher 10 includes a flusher body 12 coupled to a water supply line 14 and also coupled to a water output line 16 providing flush water to a toilet or urinal. Bathroom flusher body 12 is also coupled to a manual port for a manual handle used for manual embodiments only. The manual embodiments are described in U.S. Pat. Nos. 3,778,023; 5,881,993; 5,295,655, all of which are incorporated by reference for explanation and better understanding, but are not part of the present invention. The manual flush valves may be converted to automatic flushers using the modules described below. In the present automatic flusher design, the manual port is closed off using a cap 19 coupled to the manual port using a lock ring 17.

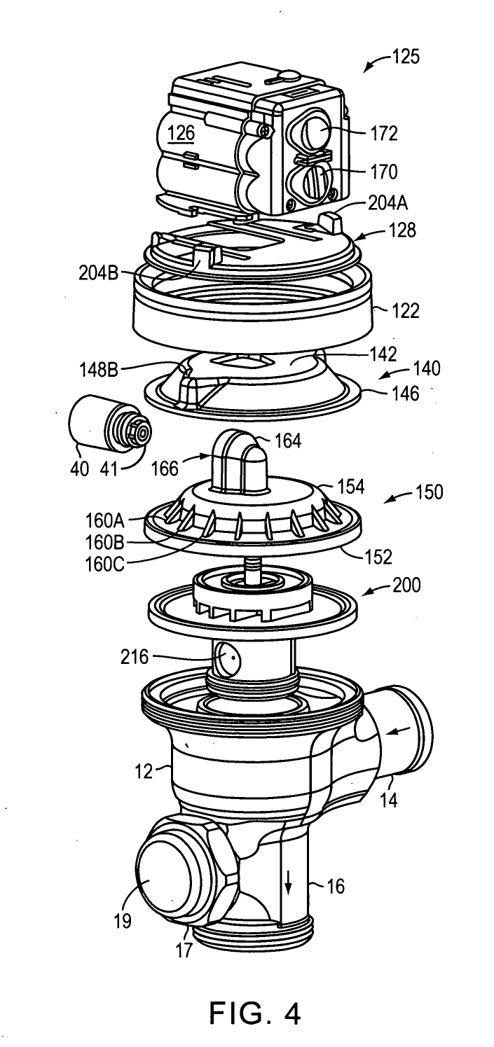

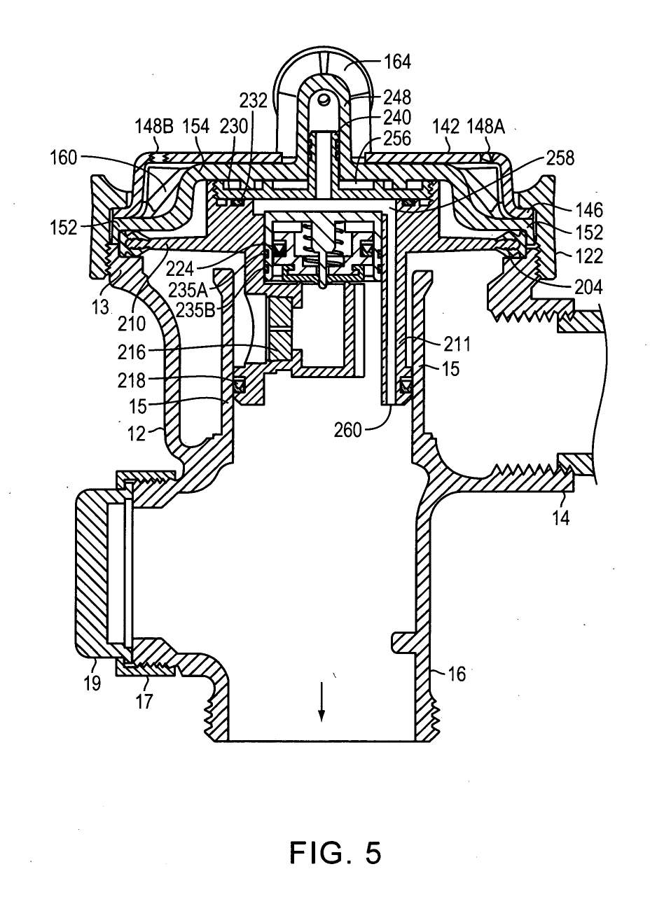

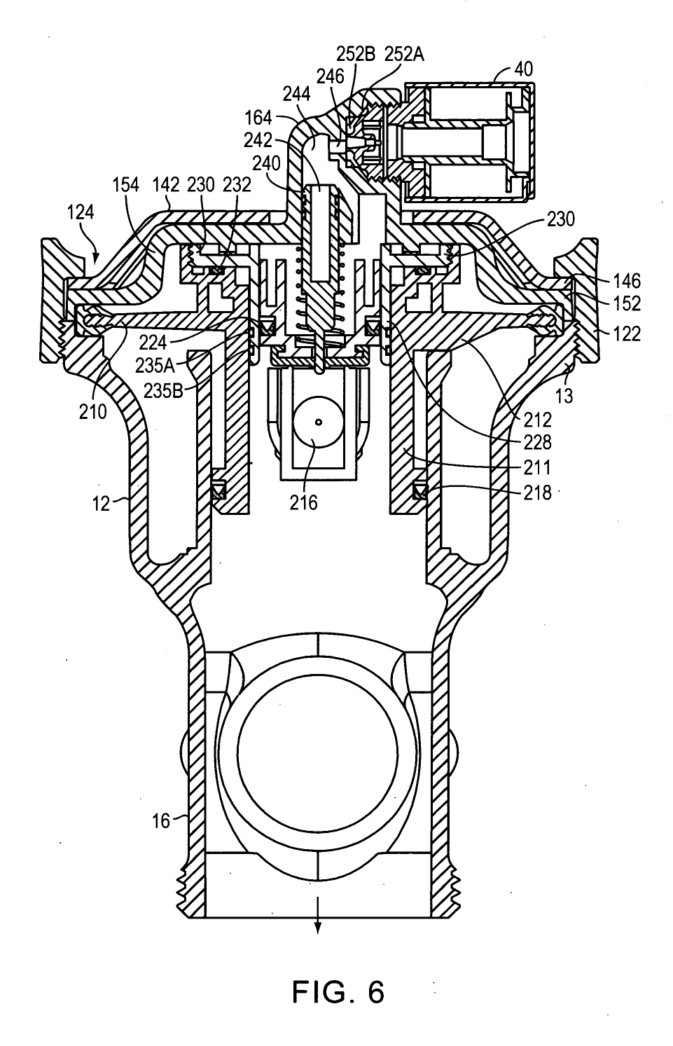

Automatic bathroom flusher 10 also includes an external flusher cover 100 enclosing electronic control module 125, shown in FIG. 4. External flusher cover 100 is preferably a dome-like outer cover specifically designed for protection and easy servicing of control module 125. Flusher cover 100 also includes a manual override button 22 used to override the flusher's sensor (e.g., an optical sensor, an ultrasonic sensor, a capacitive sensor, a heat sensor or a passive near infrared sensor). Furthermore, flusher cover 100 is designed to protect control module 125 in case of water leaks, as described below.

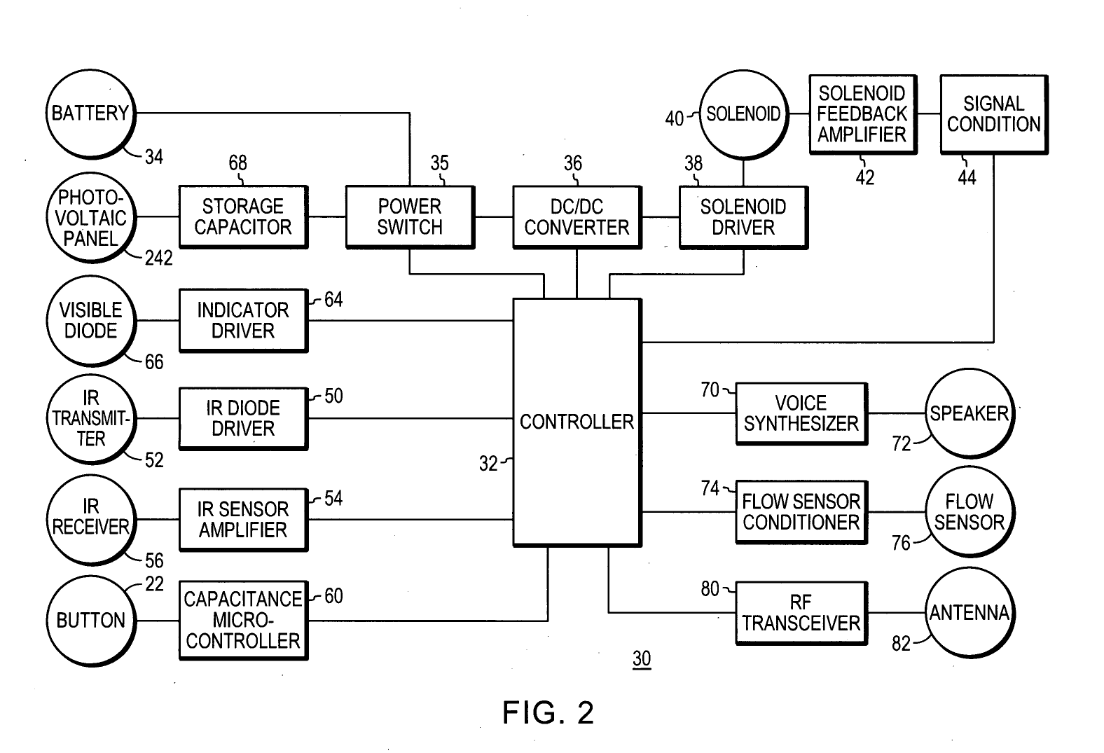

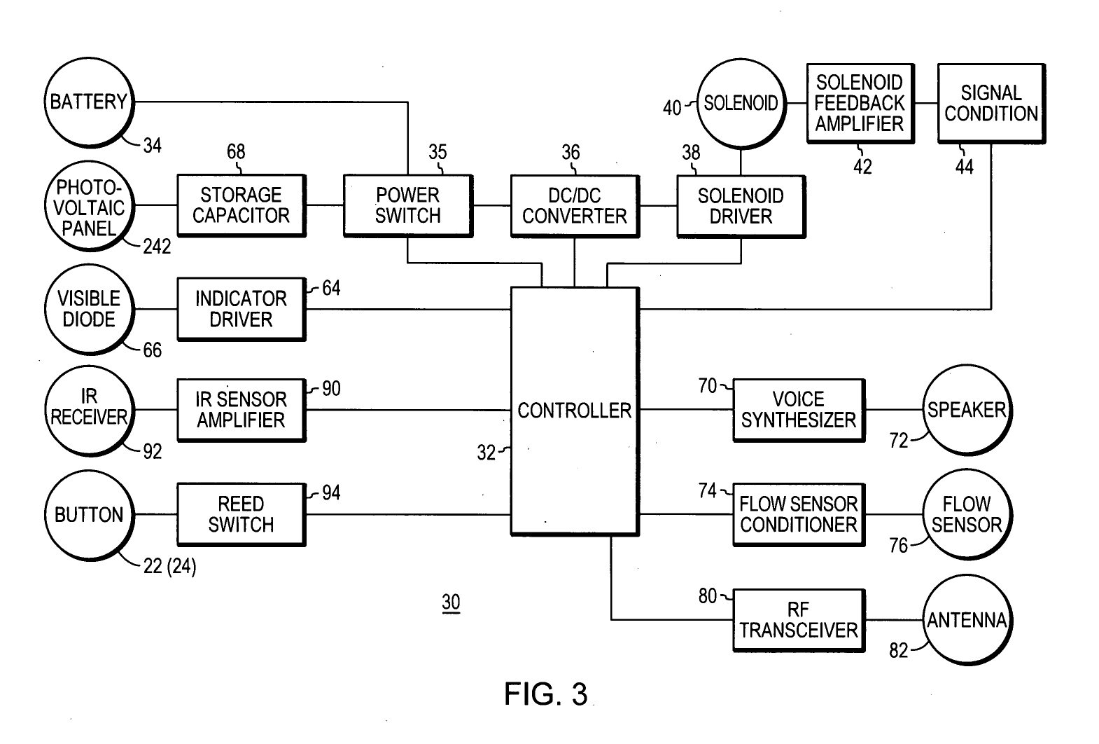

Referring still to FIG. 1, flusher cover 100 includes a main cover body 105, a front cover 110, and a top cover 115. The entire flusher cover 100 is secured in place with respect to the flusher body using an attachment ring 122 connecting a pilot plate 140 to flusher body 12 (FIG. 4). Electronic control module 125 is positioned onto an alignment plate 128, which defines the module's position and orientation with respect to the front of the flusher. Electronic control module 125 includes electronic elements that control the entire operation of flusher 10, including a sensor and a microcontroller for execution of a detection and flushing algorithm, as described in detail in connection with FIGS. 2 and 3.

FIG. 1A depicts automatic bathroom flusher 10A that includes a photovoltaic cell 242. Automatic bathroom flusher 10A includes a flusher cover 102, which comprises a main cover body 106, a front cover 114, and a top cover 116. The entire flusher cover 102 is secured in place with respect to the flusher body using attachment ring 122 connecting a pilot backup plate 140 and plastic inner cover 150 to flusher body 12 (FIG. 4). As described above, also in flusher 10A, electronic control module 125 is positioned onto an alignment plate 128, which defines the module's position and orientation with respect to the front of the flusher.

External flusher cover 100 (or 102) is designed for optimal operation and easy servicing of automatic flusher 10. Main cover body 100 provides overall protection and rigidity. Front cover 110 (and 114) and top cover 115 (and 116) have complementary shapes with main body 105 (and 106) to form a dome-like structure and to enable easy disassembly. The main body 105, front cover 1110 and top cover 115 fit together like a simple three-dimensional puzzle. In a preferred embodiment, these elements have surfaces arranged to provide a tight water seal. External flusher cover 100 (and 102) includes two long screws that hold in place top cover 115 (or 116) by tightening the screws against the respective cooperating threads located in pilot plate 140. The two screws include respective heads located inside openings 118A and 118B. This arrangement holds in place and attaches together main cover 105 (and 106) with front cover 110 (or 114) and top cover 115 (or 116), which are thus all coupled to pilot plate 140, which in turn is attached to flusher body 12 utilizing attachment ring 122. This arrangement also holds control module 125 and plate 128 in place. Detailed description of the main cover design is provided in U.S. Pat. Nos. 7,325,781 and 7,188,822, both of which are incorporated by reference.

Main flusher cover 105 (or 106) includes a side and rear surface (which has an approximately cylindrical shape), a top surface, and in front an elliptical abutting surface cooperatively arranged with the corresponding surface of front cover 110 (or 114). Main body 105 (or 106) also includes an upper side abutting surface cooperatively arranged with the corresponding surface of top cover 115 (or 116). In flusher cover 100, top cover 115 includes a manual flush button 22. In flusher cover 102, front cover 114 includes a manual flush button 24 and top cover 116 includes photovoltaic panel 242. Front cover 110 (or front cover 114) include an optical window 112.

The flusher cover is designed to service automatic flusher 10B without disconnecting the water supply provided via input line 14, or removing retaining ring 122. Top cover 115 (or 116) can be removed by loosening the two screws and lifting the top cover. Upon lifting top cover 115 (or 116), front cover 110 (or 114) may be removed by a sliding upward motion facilitated by the grooves in main body 105. Furthermore, upon removing the two screws, the entire cover can be lifted and electronic control module 125 can be accessed. This enables servicing or replacing electronic control module 125 while actuator 40 still remains in place and provides a seal to the external water supply. For example, the batteries may be replaced by removing the back cover of module 125. After the batteries are replaced, the back cover is attached and tightened to provide a water seal. Thus, the batteries may be replaced by untrained personnel without any need to call a plumber and closing the external water supply. Electronic control module 125 also includes IR source assembly 170 and IR receiver assembly 172 separated by a divider element that includes a light barrier, which prevents cross-talk between the source and the receiver

FIGS. 2 and 3 illustrate control electronics 30 used in bathroom flusher 10 (or 10A). Several of the electronic elements shown in FIGS. 2 and 3 are optional and are used with various embodiments of the automatic bathroom flushers. The control electronics used with an active IR sensor is shown in FIG. 2. The active IR sensor includes an IR transmitter for emitting an IR beam and an IR receiver for detecting the reflected IR light. The control electronics used with a passive sensor is shown in FIG. 3. The passive sensor uses passive optical detector for detecting presence of a user.

Control electronics 30 includes a controller 32 powered by a battery 34. Controller 32 is preferably a microcontroller MC9S08GT16A made by Freescale®. The microcontroller executes various detection and processing algorithms, which are preferably downloaded. However, the controller and algorithms may also be implemented in the form of dedicated logic circuitry, ASIC, or other. The control electronics 30 includes a power switch 35, a DC-DC converter 36, a solenoid driver 38. Solenoid driver 38 provide a drive signal to a solenoid 40 monitored by a solenoid feedback amplifier 42, and a signal conditioner 44. Controller 32 communicates with an indicator driver 64 for driving a visible diode 66 (e.g., a blue diode) for communications with the user. The active optical sensor includes an IR diode driver 50 providing power to an IR transmitter 52, and an IR sensor amplifier 54 receiving a signal from an IR receiver 56. The entire operation is controlled by controller 32.

The IR diode driver 50 is designed to progressively increase and decrease the optical power output according to target and environment conditions. The same applies to the IR receiver using IR sensor amplifier 54. Usually only one of the modes is used both since one is enough to achieve the purpose. The following are examples of the conditions: If the environment is too IR bright, the system boosts the optical emission signal. If the target is too close, such as in the closet, the system reduces the IR signal to save power. If the target is not sufficiently IR reflective, the system boosts the IR signal either from the IR transmitter 52 or using IR sensor amplifier 54.

In the embodiment of FIG. 2, the system uses a capacitive controller 60, which monitors the activation of buttons 22 (or 24) The system also uses an optional voice synthesizer 70 connected to a speaker for providing a user interface. An optional flow sensor conditioner 74 connected to a flow sensor 76 is used for detecting water flow through the flusher. Alternatively, a sensor may be used to detect overflow of water in a toilet or urinal and provide signal to controller 32 for shutting down the automatic flusher.

The system also uses an optional RF transceiver 80 connected to an antenna 82 for wireless communication with a remotely located central controller or network. The present design may be deployed with a network of wirelessly connected bathroom flushers and sanitary appliances. The remotely located network enables monitoring and gathering of information concerning the flushers and appliances. The communication between the flushers and appliances uses preferably low frequency RF signals, and the communication to the remotely located network node uses preferably a high frequency RF signals.

In general, wired or wireless data communication is used for transmitting information as it relates to the well being of the bathroom flushers and sanitary appliances. The transmitted information (together with the ID of the device) may include the battery voltage, number of flushes, the unit is on run-on condition (cannot turn off), no water condition (cannot turn on), etc. Using RF transceiver 80 and antenna 82, the system can receive information such as command remotely initiated from somewhere else. The fixture may talk to each other in a networked fashion. The fixtures may talk to a proximal central unit and the said unit may transmit data (wired or wireless) to a wider network such as internet. In preferred embodiment; the user initiates a location wide diagnostic mission by requesting each fixture to turn on and then off. In turn, each fixture reports successful/unsuccessful operation. The fixture may also report other variables such as battery voltage, number of flushes, etc. The user then gathers the information and schedules a maintenance routing according to results. This is particularly useful in establishments such as convention centers, ballparks, etc. where the maintenance personnel currently send crews to monitor the well being of the fixtures and take notes manually prior to an event.

Microcontroller MC9S08GT16A is used for the following main functions: Microcontroller 32 manages the voltage regulation so that we deliver fixed amount of voltage to sections of the hardware as needed regardless of the battery voltage (DC to DC converter). Microcontroller 32 monitors manual flush buttons. In case of capacitance touch, maintain necessary functions and adjustments as the background of the environment changes over time. Microcontroller 32 monitors target by use of IR emitter and receiver circuit and act accordingly. Microcontroller 32 provides necessary signal to solenoid so it would turn on and off. Microcontroller 32 maintain self monitoring such that if the executable software goes to a dead loop then reset the program accordingly. Microcontroller 32 manages all user diagnostics input. Microcontroller 32 manages all mode settings. Microcontroller 32 monitors power source levels and take action as necessary such as close the valve and shut down operation. Microcontroller 32 monitors solenoid latch and unlatch signals to conserve power.

Another embodiment of the control electronics is described in PCT Publications WO2005/056938 and WO2004/061343, both of which are incorporated by reference.

According to another embodiment, the control electronics includes a microcontroller that is an 8-bit CMOS microcontroller TMP86P807M made by Toshiba. The microcontroller has a program memory of 8 Kbytes and a data memory of 256 bytes. Programming is done using a Toshiba adapter socket with a general-purpose PROM programmer. The microcontroller operates at 3 frequencies (f_{c}=16 MHz, f_{c}=8 MHz and fₛ=332.768 kHz), wherein the first two clock frequencies are used in a normal mode and the third frequency is used in a low power mode (i.e., a sleep mode). The microcontroller operates in the sleep mode between various actuations. To save battery power, microcontroller periodically samples optical sensor unit for an input signal, and then triggers power consumption controller. Power consumption controller powers up signal conditioner and other elements. Otherwise, the optical sensor unit, the voltage regulator (or the voltage boost) and the signal conditioner are not powered to save battery power. During operation, the microcontroller also provides indication data to an indicator, e.g., a visible diode 66 or speaker 72. Control electronics may receive a signal from the passive optical sensor or the active optical sensor described above. The low battery detection unit may be the low battery detector model no. TC54VN4202EMB, available from Microchip Technology. The voltage regulator may be the voltage regulator part no. TC55RP3502EMB, also available from Microchip Technology (http://www.microchip.com). Microcontroller may alternatively be a microcontroller part no. MCU COP8SAB728M9, available from National Semiconductor.

In the embodiment shown in FIG. 3, controller 32 monitors reed switch 94 activated by manual flush button 22. The manual flush button switch is formed by a reed switch, and a magnet. When the button is pushed down by a user, the circuitry sends out a signal to the clock/reset unit through manual signal IRQ, then forces the clock/reset unit to generate a reset signal. At the same time, the level of the manual signal level is changed to acknowledge to microcontroller 32 that it is a valid manual flush signal.

Control electronics 30A shown in FIG. 3 uses passive optical detector including a sensor amplifier 90 and an optical receiver 92. The passive optical detector is described in detail in PCT Publications WO2005/056938 and WO2004/061343, both of which are incorporated by reference.

Referring also to FIG. 1A, bathroom flusher includes one or several photovoltaic cells 242 for producing voltage that is proportional to the amount of light that it receives. When system 30 or 30A powers up and starts operation, the system registers this voltage and continuously monitors the voltage thereafter. At first time power up, if there is no voltage from the photovoltaic cell, this means dark environment and therefore the unit marks the time and count for a predetermined amount of time. It the time is long enough, such as hours and days, and there is no target detected within the same period of time then the flusher system is powered up but no body is using the bathroom (i.e., the lights are turned off) and therefore the system goes into a power saving mode. In this mode, the system scans for target at a much slower frequency to conserve battery power. The system may also shut down or slow down other functions such as scanning the override buttons, battery voltage, etc. Additional embodiments are described in PCT Application PCT/US2008/008242, filed on Jul. 3, 2008, which is incorporated by reference.

If there is no voltage from the photovoltaic cell, but yet the system acquires a valid target then the system indicates an error (that is, the photovoltaic cell is broken or malfunctioning or the connections and/or the circuit that relates to photovoltaic cell is broken.) In such case the system can disable all or some of the functionalities related to the photovoltaic cell. These functionalities are monitoring light or dark conditions of the environment, target shadow detection, power generation, etc.

After the first time power up, the system monitors the photovoltaic cell function normally. In such case the module would monitor the photovoltaic cell voltage continuously (in normal operation mode). In cases, where the output voltage is sufficient, the system uses the corresponding energy for flushing, or stores the in a rechargeable device for later use. The rechargeable device may be a capacitor or a rechargeable cell/battery. If the photovoltaic cell voltage does not provide sufficient power for operation, there may be a condition where the target is casting shadow on the photovoltaic cell. In such case, the system uses the low voltage information as a supplement to the target detection algorithm, whereby prior to the condition the flusher may be in slow operation mode. In this mode of operation, the system conserves energy. Each target is detected using the detection algorithms (for the active or passive sensor) and the photovoltaic information provides a supplemental data.

If the system detects valid targets using the active or passive sensor algorithm, and yet the photovoltaic cell voltage is low or zero over several detection cycles, an error condition is indicated. In such case, the system deems the photovoltaic cell broken and ignores functionalities related to the photovoltaic cell, using just the battery power.

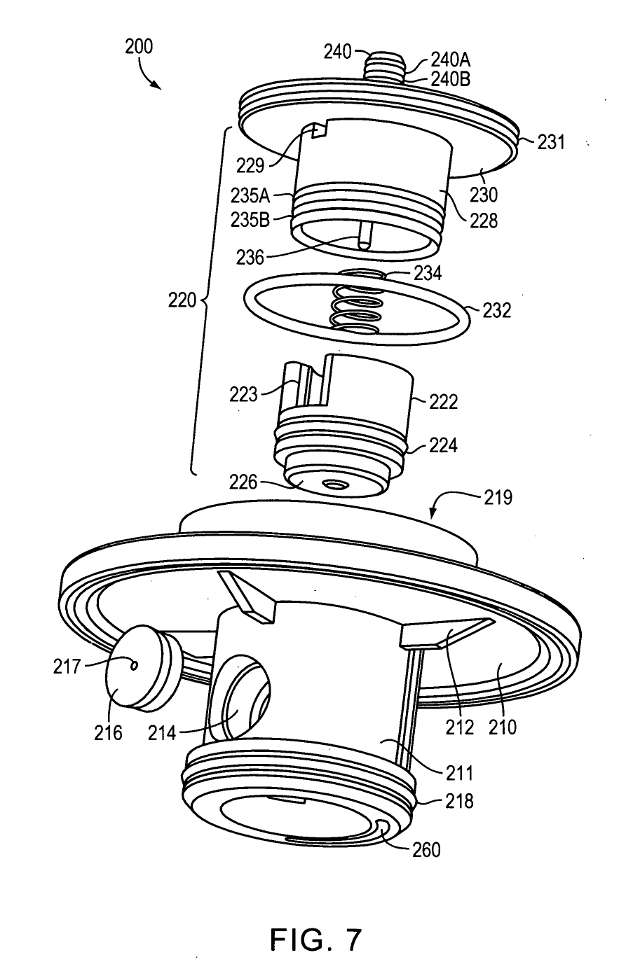

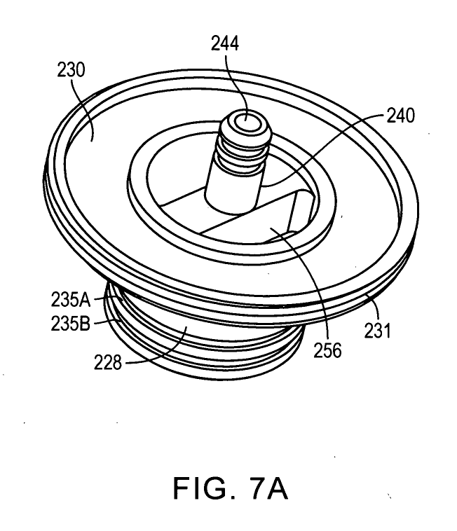

Referring to FIGS. 4 and 7, a valve cartridge 200 opens and closes water flow between input pipe 14 and output 16. Valve cartridge 200 is design to fit into 12 of a standard bathroom flusher and thus can replace a diaphragm assembly of a piston assembly of a bathroom flusher (such as ROYAL® flush valves). Valve cartridge 200 includes a main cartridge body having a cartridge plate 210 and a cartridge cylinder 211 coupled also using reinforcement elements 212. Cartridge cylinder 211 includes an opening 214 for a flow regulator 216. Valve cartridge 200 also includes a fram piston assembly 220 designed to fit inside an opening 219. Fram piston assembly 220 includes a movable fram piston 225, which is movable within a guiding enclosure 229 coupled to an interface plate 231. Movable fram piston 227 includes a seal 226, a guiding structure 222 and a lip seal 224. Movable fram piston 227 is designed to slide over a guiding pin 236, which includes an elongated V-shaped or U-shaped groove 238. Preferably, groove 238 is linearly located along pin 236. Alternatively, groove 238 is helically positioned along pin 236. Alternatively, pin 236 includes two or three grooves of smaller sizes. Guiding structure 222 includes a resistance relief opening 223 cooperatively designed with opening 229.

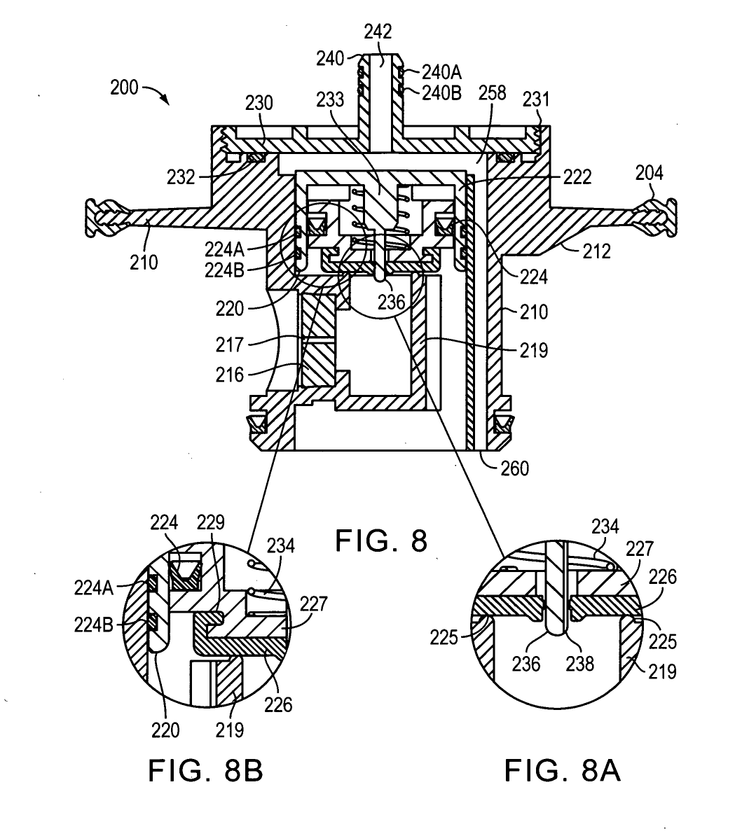

Fram piston assembly 220 also includes an O-ring 232 and a spring 234 placed over guiding pin 236 and located inside guiding structure 222, while being in contact with movable fram piston 227 constructed to slide over guiding pin 236. Seal 226 preferably includes a pliable part backed by a harder support part. Seal 226 has a diameter of 0.0803 inch and guiding structure 222 has a length of 0.6 inch. In general, the ratio of the diameter to length is larger than 1 and preferably larger than 1.3 to enable smooth movement of fram piston 225 inside guiding enclosure 229. Interface plate 231 fits inside opening 219 in cartridge cylinder 211 and is attached to it using threads 231. Guiding enclosure 229 and interface plate 231 are sealed with respect to the inside surface of cylinder cartridge 211 using O-rings 224A, 224B and 232, when interface plate 231 is tightened inside opening 219 using threads 231, as shown in FIG. 8. Electronic control module 125 is positioned on alignment plate 128, which in turn is located in contact with pilot plate 140. Plate 140 includes an opening designed to accommodate top part of pilot cap 164 of plastic inner cover 150.

Pilot backup plate 140 includes a peripheral ring 146 and an opening 142. Pilot backup plate 140 is preferably made of a brass sheet metal (preferably a heavy wall brass sheet metal) by stamping. Pilot backup plate 140 includes two treaded holes 148A and 1486 designed to receive two screws 118A and 1188. Pilot backup plate 140 includes an opening designed to accommodate top part of pilot cap 164 of plastic inner cover 150. The inner shape of pilot backup plate 140 is designed to receive plastic inner cover 150, wherein the two shapes are complementary. Plastic inner cover 150 may include one, two, or several lugs, and the plate 140 may include one, two, or several slots for positioning and easy orientation during the assembly. Preferably, plastic inner cover 150 is made of an injection molded engineered thermoplastic that has a high tensile strength and good chemical resistance. Preferably, plastic inner cover 150 is made of an acetal copolymer, such as Celcon M90, which provides inherent lubricity, high flexural modulus and high tensile strength, low coefficient of friction and good chemical resistance.

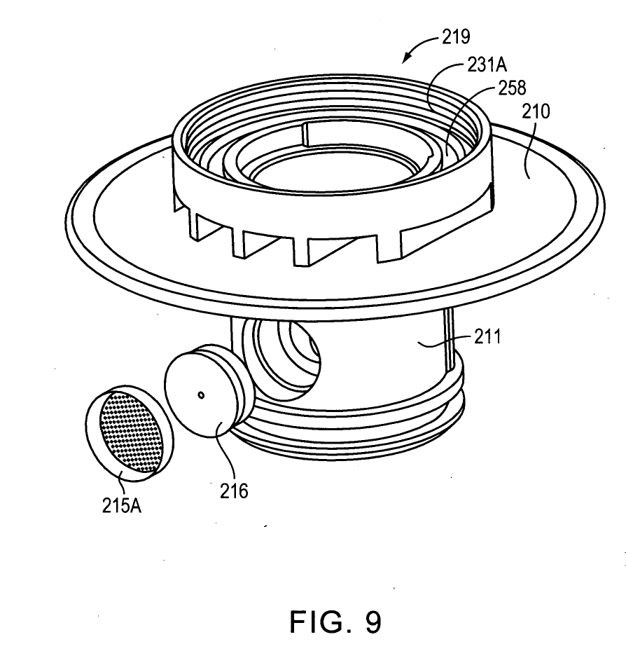

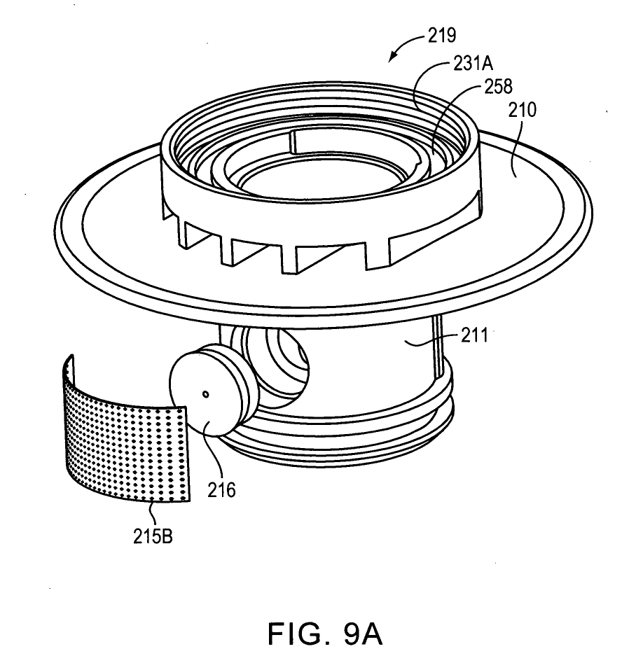

FIGS. 9 and 9A show alternative embodiments of flusher valve cartridge 200 including filters 215A and 215B located in from of flow regulator 216. The flow control valve or the flow regulator includes a regulator housing with a passage channel and one, two or several control devices. The control device may have a central body surrounded by an annular throttle body made from an elastic material. The throttle body bounds a control gap between itself and an adjacent peripheral surface provided with control recesses that are spaced apart from each other in a circumferential direction and which are oriented in a flow direction. The passage cross section of the control gap can be changed by the throttle body deforming under a pressure difference formed by the fluid flow. The control devices may be arranged in the longitudinal extent of the passage channel. The two control devices may have different flow rates or different pressure ranges. The first of the control devices may have at least one bypass channel or a passage opening for at least one of a lower flow rate or a lower pressure range, and the passage opening can be opened and closed, and is opened for a higher flow rate or a higher pressure range and is closed for the lower flow rate or the lower pressure range.

The one or more passage openings can be opened and closed as a function of the flow direction. The control devices may be arranged at a distance from each other in the regulator housing. The flow regulator may include a closing element adjustable between an open position and a closed position for opening and closing the passage openings of the first control device for the lower flow rate. The closing element may be constructed as a closing peg and is supported so that it can shift in an axial direction in the control device for the higher flow rate. The control device for the higher flow rate has a guide opening for the closing element that is open towards an axial end of the regulator housing allocated to the control device. The central bodies of the control devices may be each constructed as control cones tapering uniformly. The flow control valve may have a design as described in U.S. Pat. No. 7,527,075, which is incorporated by reference.

A flow control valve including a fluid flow passage extending between an inlet and an outlet and including an orifice and an elastomeric diaphragm. The orifice may have two seats each having a main support surface defining one or more channels extending in a radial direction of the orifice. The diaphragm is disposed in the fluid flow passage and has an end face that is urged against one of the seats of the orifice by the flow of the fluid through the valve. The orifice may be oriented so that the first seat opposes the diaphragm or may be oriented so that the second seat opposes the diaphragm. The first and second seats may define similar contours such that the valve provides a first controlled flow rate when the orifice is positioned in either the first or second orientation. The first and second seats may define dissimilar contours so that the valve provides a first controlled flow rate when the orifice has the first orientation and the valve provides a second, different controlled flow rate when the orifice has the second orientation. The flow control valve may have a design as described in U.S. Pat. No. 6,595,235, which is incorporated by reference.

The flow control valve may have a flow restrictor (e.g., having a spherical shape) disposed in a cavity and freely moveable between a first position in contact with a first wall, and a second position in contact with a second wall of the cavity. There is a large flow area past the flow restrictor in the first position, and small flow area past the flow restrictor in the second position. There are two ports having a center offset from a centerline of the flow restrictor relative to the longitudinal axis of the cavity.

The flow valve is designed so that the fluid flowing from the port in the first wall to the port in the second wall meets greater resistance than flowing from the port in the second wall to the port in the first wall. The flow valve may have the cross-sectional area of the cavity may have a frusto-conical shape. The cavity may have a plurality of interconnected cylindrical portions. The housing may be formed by a plurality of adjacent plate members. The flow control valve may have a design as described in U.S. Pat. No. 6,631,738, which is incorporated by reference.

The flow control valve may include a flow channel and an annular flow restrictor made of elastic material pushed onto and encircling a fastening post located in the flow channel. The post has at least two fastening webs oriented opposite to a direction in which the elastic material is pushed on, and has free ends that engage the flow restrictor from behind in a securing manner. The flow restrictor limits a control gap located between the flow restrictor and at least one fixed part of the housing, such that a flow cross-section of the control gap is adjustable by the flow restrictor. The flow restrictor deforms under a pressure difference that arises during flow. The fastening webs can be flexibly inwardly deflected. The fastening webs may engage the flow restrictor from behind with a holding cam or an expansion that enlarges the web cross-section free end of each of the webs. The fastening post may include one, two, or two of the fastening webs arranged crosswise. The fastening webs may be distributed at uniform intervals around a periphery of the post. The fastening webs may be separated from one another by longitudinal slots formed in a wall of the fastening post. The flow control valve may have a design as described in U.S. Pat. No. 6,695,011, which is incorporated by reference.

Flusher valve cartridge 200 may utilize flow regulators manufactured by Neoperl Corporation. Specifically, flow regulator 216 may be the H-US type flow regulator part no. 58.7831.1 (providing 0.75 GPM of water flow), or flow regulator part no. 58.7833.1, (providing 1.75 GPM of water flow), or flow regulator part no. 58.7834.1, (providing 2.20 GPM of water flow), or flow regulator part no. 58.7835.1, (providing 2.50 GPM of water flow). The volume of flush water depends on the flow regulator and the open time of the flush valve. The filter may be used to prevent clogging of the flow regulator.

The flusher valve receives water at input port 14. Water flows across flow regulator 216 and exerts pressure onto seal 226, which in the closed state presses against sealing surface 225. In the closed state, water flows inside groove 238 into the fram chamber where spring 234 is located. The fram chamber is in communication with the pilot chamber 149. That is, groove passage 238 provides pressure communication with pilot chamber 149. To initiate a flush, microcontroller 32 sends open signal that triggers drive voltage to solenoid actuator 40. Solenoid actuator 40 relieves the pressure in pilot chamber 149 by permitting fluid flow between passage 240 and exit passage 258. This reduces water pressure inside the fram chamber and fram piston 227, including seal 226, moves away from surface 225. When fram piston 227 moves away from surface 225, water flows through flow regulator 216 at surface 225 to output 16. To terminate the flush, microcontroller 32 sends close signal that triggers drive voltage to solenoid actuator 40. As the pressure inside the fram chamber increases, fram piston 227 assisted by spring 234 slides down and seals passage 225, which terminate the water flow from input 14 to output 16. Detailed operation of the fram piston is also described in U.S. Pat. No. 7,437,778, which is incorporated by reference.

In general, solenoid actuator 40 includes a bobbin having magnetically wound electrical windings, and an armature linearly movable within the bobbin. The latching versions of the actuator include a ferromagnetic pole piece magnetically coupled to a permanent magnet acting against an armature spring. The permanent magnet is arranged for latching the armature in the open state. The armature spring maintains the armature in the extended position (i.e., the closed position with the plunger preventing flow through passage 37). To flush the toilet, the microcontroller provides a control signal to a drive circuit that provides current to the solenoid windings of actuator 40. The drive current generates a magnetic field that tends to concentrate in a flux path in the ferromagnetic armature and the pole pieces as described in the PCT Application PCT/US01/51098. The latching actuator (i.e., bistable actuator) requires no current to keep the valve open.

In the non-latching versions, there is no permanent magnet to hold the armature in the open position, so a drive current must continue to flow if the pilot valve is to remain open (i.e., the drive current is needed to hold the plunger away from the pilot seat allowing flow through passage 37). The pilot valve can be closed again by simply removing the current drive. To close the pilot valve in the latching actuator, on the other hand, current must be driven through the windings in the reverse direction so that the resultant magnetic field counters the permanent-magnet field that the actuator experiences. This allows the armature spring to re-seat the plunger of actuator 40 in a position in which the spring force is again greater than the magnetic force. Then, the actuator will remain in the pilot-valve-closed position when current drive is thereafter removed.

As described in the PCT application PCT/US02/38758, which is incorporated by reference, piloting button 41 is screwed onto the distal part of actuator 40 to create a valve. Specifically, the plunger of actuator 40 acts onto the valve seat inside piloting button 41 to control water flow between the input and output passages. This arrangement provides a reproducible and easily serviceable closure for this solenoid valve. Co-operatively designed with piloting button 41 and actuator 40, there are several O-rings 252A, 252B, which provide tight water seals and prevent pressurized water from entering the interior of the cover. The O-rings also seal piloting button 41 within the chamber inside the top part 164 and prevent any leakage through this chamber into the bore where actuator 40 is partially located. It is important to note that these seals are not under compression. The seat member precisely controls the stroke of the solenoid plunger as mentioned above. It is desirable to keep this stroke short to minimize the solenoid power requirements.

Electronic control module 125 includes the light source assembly and the receiver assembly including the electronics. The operation of the light source and detector and the entire control electronics is described in the PCT application PCT/US02/38758. Another embodiment of the optical sensor is described in U.S. Pat. No. 6,212,697, which is incorporated by reference.

While the invention has been described with reference to the above embodiments, the present invention is by no means limited to the particular constructions described above and/or shown in the drawings. The present invention also comprises any modifications or equivalents within the scope of the following summarized paragraphs.

1. An automatic toilet room flush valve, comprising:
a valve body including an inlet and an outlet;
a valve cartridge, disposed inside said valve body, including a valve member and a flow regulator, said flow regulator limiting water flow, said valve member being constructed and arranged to control water flow from said inlet to said outlet; and
an external cover designed for enclosing an electronic control module and a sensor.

2. The flush valve of claim 1 wherein said valve member includes a fram assembly.

3-6. (canceled)

7. The flush valve of claim 1 wherein said valve member includes a diaphragm.

8. The flush valve of claim 1 wherein said valve member includes a piston.

9. The flush valve of claim 1 including an electromagnetic actuator, controlled by a controller and controlled electronics, constructed and arranged to release pressure in a pilot chamber and thereby initiate movement of said valve member from said closed position to said open position.

10-14. (canceled)

15. The flush valve of claim 9, wherein said actuator is actuated by a controller receiving a signal from a sensor.

16. The flush valve of claim 15 wherein said sensor includes an infrared sensor.

17. The flush valve of claim 15 wherein said sensor includes an ultrasonic sensor.

18. The flush valve of claim 15 wherein said sensor includes a presence sensor.

19. The flush valve of claim 15 wherein said sensor includes a motion sensor.

20. The flush valve of claim 1 wherein said valve assembly includes a filter for filtering water.

21. A sensor-based automatic flusher system, comprising:
a flusher body including a water conduit having at least one inlet for receiving water and at least one outlet for providing water to a toilet or a urinal;
an optical sensor;
a control circuit arranged to control operation of said optical sensor,
said control circuit including a controller executing an algorithm identifying behavior of a user over a predefined time period within a sensing field of said optical sensor and based on said behavior issuing a flush command for a predefined amount of water; and
a main valve controlled by an actuator receiving signals corresponding to said flush command for switching between an open state of said valve and a closed state of said valve; said open state permitting water flow of said amount of water, and a closed state of said valve preventing fluid flow from said outlet.

22. The sensor-based automatic flusher system of claim 21 wherein said controller is programmed to execute an algorithm including several predefined target states based on a possible behavior of said user over a predefined time period within said sensing field of said optical sensor.

23. The sensor-based automatic flusher system of claim 22 wherein said controller algorithm identifying said user initially moving in and thus entering a first of said predefined target states and progressing through a succession of said target states and later moving away from said optical sensor.

24. The sensor-based automatic flusher system of claim 23 wherein said target states include sitting and standing action of said user.

25. The sensor-based automatic flusher system of claim 21 wherein said controller issues said flush command including a half-flush of said water amount.

26. The sensor-based automatic flusher system of claim 21 wherein said controller issues said flush command including a full-flush of said water amount.

27. The sensor-based automatic flusher system of claim 21 wherein said controller issues said flush command after a predefined time period regardless of any action by said user.

28. The sensor-based automatic flusher system of claim 27 wherein said predefined time period is 24 hours.

29-34. (canceled)

35. A method for controlling a sensor-based automatic flusher, comprising the acts of:
providing a flusher body including a water conduit having at least one inlet for receiving water and at least one outlet for providing water to a toilet or a urinal and being controlled by a main valve controlled by an actuator;
providing an optical sensor and a control circuit including a controller;
initiating said optical sensor to sense a user;
executing an algorithm for identifying behavior of a user over a predefined time period within a sensing field of said optical sensor;
issuing a flush command for a predefined amount of water based on said behavior of said user; and
switching between an open state of said main valve and a closed state of said main valve; said open state permitting water flow of said amount of water, and a closed state of said valve preventing fluid flow from said outlet.

36. The method for controlling a sensor-based automatic flusher according to claim 35 including identifying predefined target states based on a possible behavior of said user over a predefined time period within said sensing field of said optical sensor.

37. The method for controlling a sensor-based automatic flusher according to claim 36 including identifying said user initially moving in and thus entering a first of said predefined target states and progressing through a succession of said target states and later moving away from said optical sensor.

38. The method for controlling a sensor-based automatic flusher according to claim 37 wherein said target states include sitting and standing action of said user.

39. The method for controlling a sensor-based automatic flusher according to claim 35 wherein said issuing said flush command includes a half-flush of said water amount.

40. The method for controlling a sensor-based automatic flusher according to claim 35 wherein said issuing said flush command includes a full-flush of said water amount.
